(19) United States
(12) Patent Application Publication
(10) Pub. No.: US 2011/0106622 A1
(43) Pub. Date: May 5, 2011

(54) Real-Time Mobile Advertising Marketplace

(75) Inventors: John Henry Kuhlman, Redmond, WA (US); Bruce Nowjack, Bainbridge, WA (US); Joerg Christof Zender, Renton, WA (US); Eric Edgar Lofdahl, Kent, WA (US)

(73) Assignee: Wireless Service Corp., Seattle, WA (US)

(21) Appl. No.: 12/912,698

(22) Filed: Oct. 26, 2010

Related U.S. Application Data
(60) Provisional application No. 61/255,036, filed on Oct. 26, 2009.

(51) Int. Cl. G06Q 30/00

(52) U.S. Cl. 705/14.53; 705/14.64; 705/14.69

(57) ABSTRACT

Real-time mobile advertising marketplace for messaging advertisement campaigns. Publishers may showcase their mobile inventory in one ad marketplace location to maximize their use of inventory and enable competitive pricing for advertisers. Advertisers are provided an interface to Ad Marketplace for viewing available inventory, pricing, and demographic reach. Once various selections are made and the advertising is transmitted to a publisher in real-time for viewing and approval. Publishers may also define new inventory, review pending inventory buys, and/or accept or reject advertising requests. Once approved, the advertisements may be queued for serving into scheduled campaigns for various mobile devices using, for example ad insertion and ad requestor mechanisms. As the advertisement campaigns are running, advertisers and/or publishers can both view real-time performances metrics, such as impressions served, response rates, and/or revenue earned.

### CROSS-REFERENCE TO RELATED APPLICATIONS

This application claims benefit of U.S. provisional applications 61/255,036 filed Oct. 26, 2009, the entire contents of which are hereby incorporated by reference. This application is also related to commonly assigned application, entitled “Method and System for Real-Time Insertion of Advertisements into Mobile Messages,” filed concurrently herewith, the contents of which are hereby incorporated by reference and pending U.S. application Ser. No. 11/854,461, filed Sep. 12, 2007, the entire contents of which are also hereby incorporated by reference.

### TECHNICAL FIELD

Embodiments relate generally to managing real-time mobile advertisement campaigns, and, more particularly, but not exclusively to a system for publishers and advertisers to manage SMS message advertisement campaigns that may be linked to interactive television shows, or similar media activities.

### BACKGROUND

The mobile phone, and other mobile devices, are in such common use today that the mobile phone is often referred to as the seventh mass media channel, after print, recordings, cinema, radio, television, and the internet. It is often considered to be as revolutionarily different from the internet as television is from the radio. Today's mobile devices provide not only a mechanism to place telephone calls but are often used to send and receive text messages. These messages can be phone-to-phone personal communication, or can be originated from a source other than another phone. These externally generated messages can include news, weather, sports, chat, financial alerts or links to other content; and can be in direct response to user entries or queries, or the result of a user signing up for a service. These phones can also to receive various media content that includes news, weather, and other alerts, video games, ringtones, as well as video, television and other multimedia content. With the advent of text messages and media content on the mobile device, and the large number of mobile devices in use around the world, has come a tremendous marketing opportunity for advertisers. However, determining which advertisements to place with which content, and how to insert that advertising, remains complex. Thus, it is with respect to these considerations and others that the present invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 is a system diagram of one embodiment of an environment in which embodiments of the invention may be practiced;

FIGS. 2-3 provide various flowcharts of processes, useable with system 100;

FIG. 4 illustrates one embodiment of a process flow for request processing with client-to-server handshakes;

FIG. 5 illustrates one embodiment of a process flow for use with network load sharing;

FIG. 6 illustrates one embodiment of an application request processing;

FIG. 7 shows one embodiment of a network device useable as an advertisement server and/or web server in a system implementing various embodiments;

FIG. 8 illustrates one embodiment of a general top-level system overview of a process for employing the system of FIG. 1;

FIG. 9 provides one embodiment of at least some of the possible advertisement server sub-roles;

FIG. 10 illustrates one embodiment of Publisher functions;

FIG. 11 shows some samples of possible display mechanisms for basic blind/open value representations;

FIG. 12 provides one embodiment of a blind/open display of options;

FIG. 13 illustrates one embodiment of an example exclusion interface;

FIG. 14 provides one embodiment of an interface for managing exception cases for dates using appointment recurrence;

FIG. 15 illustrates one embodiment of an advertiser function tree;

FIG. 16 illustrates one embodiment of a dynamic screen for managing demographics;

FIG. 17 provides one embodiment of a discover example for demographic data;

FIG. 18 provides one embodiment of a sample method of defining a campaign;

FIG. 19 provides one embodiment, of a preview for a campaign;

FIG. 20 illustrates one embodiment of an advertising server Administrator functional tree; and

FIG. 21 illustrates one embodiment, of a menu useable for views.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Similarly, the phrase “in another embodiment” as used herein does not necessarily refer to a different embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Furthermore, as used herein the following definitions are employed:
4Info A specific 3rd Party Ad Network
AA Ad Agnosticator, also called Ad Requester
API Application Programming Interface
AR Ad Inserter—the ad-requesting and inserting client
AIA Ad Insertion Agent
CID Content Identification
CP Content Provider
CPC Cost Per Click. The cost for each click through.
CPM Cost Per Mil. The cost per 1000 impressions.
CTA Call To Action. This is the portion of the ad that calls the viewer to act upon the ad.
DART A specific 3rd Party Ad Network IID (or InvID) Inventory Identification.
Jumptap A specific 3rd Party Ad Network
MDN Mobile Directory Number
MT Mobile Terminate
MO Mobile Originate
NetID Network ID
Ringleader A specific 3rd Party Ad Network
SMPP Short Message Peer-to-Peer
SMS Short Message Service (text message)
Trafficker Term used to describe the entity that performs yield management
URL Uniform Resource Locator
WAP Mobile web
XIR A specific message Router Agent
XML Extensible Markup Language

The following briefly describes the embodiments of the invention in order to provide a basic understanding of some aspects of the invention. This brief description is not intended as an extensive overview. It is not intended to identify key or critical elements,' or to delineate or otherwise narrow the scope. Its purpose is merely to present some concepts in a simplified form as a prelude to the more detailed description that is presented later.

Briefly stated, various embodiments are directed towards a system, method, and apparatus for providing a real-time mobile advertising marketplace, and ad-insertion mechanism, for at least Short Messaging Services (SMS), Multimedia Messaging Service (MMS), and similar text and media messaging advertisement campaigns. As used herein, Publishers are the entities that generate the outgoing messages, sports alerts for example. Additionally, Advertisers are the entities that have text or media advertisements they wish to place on those outgoing messages. Thus, the Advertising Marketplace brings the two entities together, combining the message with the ad before it is sent to the end-user's phone.

In one embodiment, the advertisement campaigns are provided for use with interactive television content from various publishers of the content. Embodiments provide an onscreen inventory of scheduled mobile messaging campaigns for each television content, or other media content. Aggregated viewer data may then be offered that allows further targeting by various criteria, including demographic, geographic, behavioral, and/or psychographic. Time and location sensitive campaigns may also be provided. Publishers may further showcase their mobile inventory (media content) in one location to maximize their use of inventory and enable competitive pricing for advertisers. Advertisers are provided an interface to a web-based advertisement (Ad) Marketplace for viewing available inventory, pricing, and demographic reach. Once various selections are made and the advertising is uploaded with associated preferences, such information may be transmitted to a publisher in real-time for viewing and approval. Publishers may also interact with Ad Marketplace to define new inventory, review pending inventory buys, and/or accept or reject advertising requests. Once approved, the advertisements may be queued for serving into scheduled campaigns for various mobile devices using, for example, Ad insertion and Ad requestor mechanisms described further below. As the advertisement campaigns are running, advertisers and/or publishers can both view real-time performance metrics, such as impressions served, response rates, and/or revenue earned.

Thus, publishers of text and media content for consumption at a mobile device may tap into a variety of new revenue streams using the various embodiments disclosed herein. Moreover, publishers may enhance existing programming and advertising with direct to consumer interactive features; take complete control of campaign matching; run test campaigns to measure success; and even measure customer response with real-time reports. Advertisers may also benefit by achieving a more diversified reach; enhance customer targeting through increased visibility into customer attributes; create time-sensitive location-based campaigns; create direct-response campaigns through consumer interactivity; capitalize on mobile advertising, and well as measure customer response with real-time reports.

Employing the Ad Marketplace network device and its web-based interface, publishers may publish and/or otherwise define available media content inventory, such as television content, or the like. Publishers may further define pricing, predicted or known volume, flight time information, as well as other parameters of the audience associated with the inventory. Using Ad Marketplace, advertisers and/or other agencies may discover the available inventory based on the above mentioned parameters, as well as others, thereby providing advanced targeting capabilities. Once an advertiser has committed to purchase available inventory, the advertiser may put advertising creatives (the various ad content) against it and define ad rotation, sequencing parameters or the like, on a global or even a unique user basis. In one embodiment, advertising space on a receiving mobile device may be constrained to 20, 40, 60, or 160 character lengths. However, in other embodiments, other character lengths may be designated by the publisher.

In at least one embodiment, a publish has final approval rights for each of the provided advertisement to make sure that they are in alignment with rules, regulations, and/or other constraints placed upon the advertisement by the publisher, as well as to avoid any conflicts between the content message and the advertisement.

Ad Marketplace further provides reporting capabilities that inform publishers and advertisers of the performance of each advertisement campaign or advertisement, including a number of successfully served impressions.

Thus, use of various embodiments of the invention allows publishers to monetize available real estate on their messaging inventory by allowing insertion of advertisements. Direct response mechanisms are also supported that include, for example, coupons/ticketing. Couponing sends electronic coupons to mobile subscribers as a way to enhance promotional campaigns. These coupons may be redeemed in stores and/or online and provide the instant gratification “push to purchase” element of mobile advertising campaigns. Other embodiments also provide for sending links to additional content or information. Other embodiments also provide for video pre/post rolls of video ad impressions into mobile video with a variety of segmentation parameters available for advertisers and agencies. Further, embodiments integrate click-to-call (CTC) phone numbers in consumer text conversations, such as interactive campaigns, sweepstakes, pools, voting, and/or mobile Web sites. Phone numbers maybe highlighted in a similar manner as a hyperlink to a URL might be. This approach may also be applied to click-to-link or click-to-video integrations. Further, embodiments enable connecting a brand with customers, providing interfaces, web based tools and the like, to create, send, and/or track a text message marketing campaign. Further, as discussed above, and elsewhere below, advertisers, agencies, and publishers are provided with real time reports and visibility into the success of campaigns. Advertisers are provided with tools to manage costs and monitor click-through-rates and impressions. Publishers are provided with the tools to obtain insight required to manage earnings and monitor fill rates and CPM.

Illustrative Operating Environment

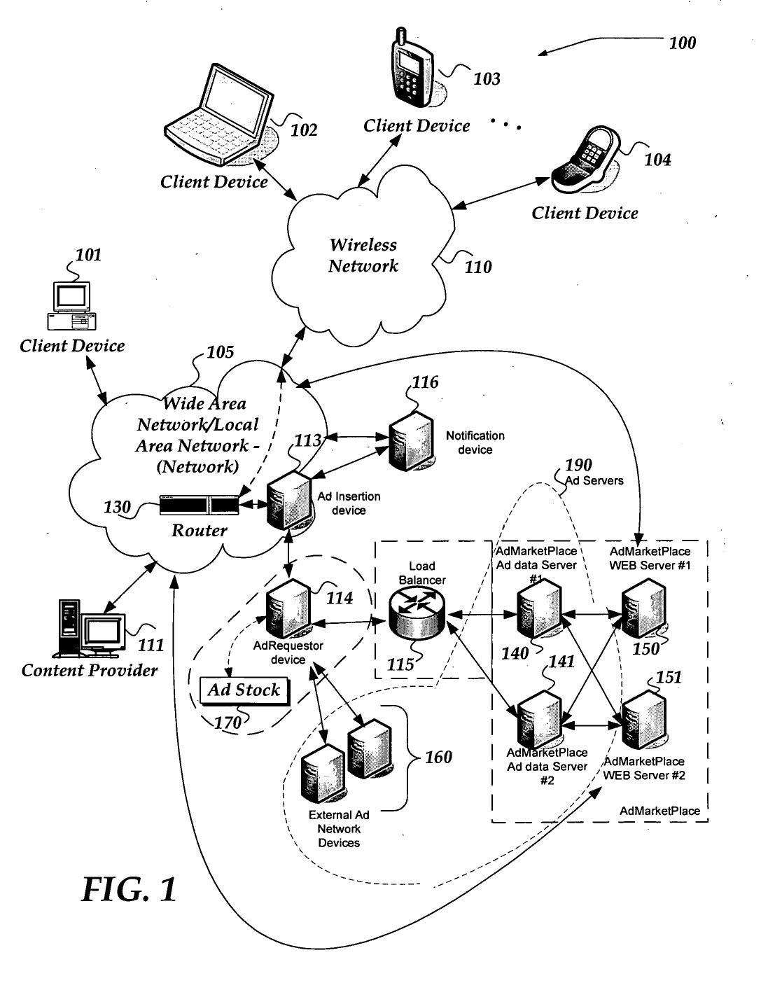

FIG. 1 shows components of one embodiment of an environment in which the invention may be practiced. Not all the components may be required to practice the invention, and variation in the arrangement and type of the components may be made without departing from the spirit or scope of the invention. As shown, system 100 of FIG. 1 includes local area networks (“LANs”)/wide area networks (“WANs”)—(network) 105, wireless network 110, client devices 101-104, content provider device 111, router 130, Ad insertion device 113, ad requester device 114, load balancer 115, ad marketplace ad servers 140-141, and ad marketplace web servers 150-151. While only two ad marketplace ad servers and ad marketplace web servers are illustrated, it should be apparent that the invention is not constrained to these, and more or less may be used. Also shown are external ad network devices 160 and ad stock 170. Collectively, the ad marketplace ad servers and ad marketplace web servers may be referred to as the Ad Marketplace, as shown by the dashed box. In one embodiment, load balancer 115 is also included as part of the Ad Marketplace.

As also shown by dashed lines, ad stock 170 and Ad requester device 114 may be considered as an integrated system, in one embodiment. For example, in one embodiment, ad stock 170 may be included within ad requester 114, while in another embodiment, ad stock 170 may reside on another network device.

As is also illustrated through dashed lines, ad marketplace servers 140-141 and external ad network devices 160 may collectively be referred to as Ad Servers 190.

Generally, client devices 102-104 may include virtually any mobile computing device capable of receiving and sending a message over a network, such as wireless network 110, or the like. Such devices include portable devices such as, cellular telephones, smart phones, display pagers, radio frequency (RF) devices, infrared (IR) devices, Personal Digital Assistants (PDAs), handheld computers, laptop computers, wearable computers; tablet computers, integrated devices combining one or more of the preceding devices, or the like. Client device 101 may include virtually any computing device that typically connects using a wired communications medium such as personal computers, multiprocessor systems, microprocessor-based or programmable consumer electronics, network PCs, or the like. In one embodiment, one or more of client devices 101-104 may also be configured to operate over a wired and/or a wireless network.

In one embodiment, client device 101 may represent a network device useable by one of a publisher of content, or an advertiser that seeks to provide advertisements to content. Thus, while a single client device is illustrated, it should be readily apparent that client device 101 represents devices useable by and for different tasks. Moreover, in one embodiment, a content publisher and/or advertiser may also employ other types of devices to interact with the invention, including client devices 102-104.

Thus, client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 101-104 also may include at least one other client application that is configured to receive content from another computing device. The client application may include a capability to provide and receive textual content, multimedia content, such as interactive and/or non-interactive television content, or the like. The client application may further provide information that identifies itself, including a type, capability, name, or the like. In one embodiment, client devices 101-104 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device.

Client devices 101-104 may also be configured to communicate a message, such as through email.SMS.MMS.IM. IRC, mIRC, Jabber, or the like, between another computing device. However, the present invention is not limited to these message protocols, and virtually any other message protocol may be employed.

In one embodiment, client devices 102-104 may subscribe to receive text alerts, such as television show announcements, or the like, from content provider 111. In one embodiment, the content may be intercepted by router 130, analyzed to determine whether the content is “ad eligible,” and if it is, send the content to the ad insertion device 113 to insert one or more advertisements. The content with the inserted advertisements may then be provided to router 130 to enable the modified content to be provided to client devices 102-104.

In one embodiment, client devices 102-104 may subscribe to receive multimedia content, such as television shows, or the like, from content provider 111. In one embodiment, the content may be intercepted by router 130, analyzed to determine whether the content is “ad eligible,” and if it is, provide the content to ad insertion device 113 to insert one or more advertisements. The content with the inserted advertisements may then be provided to router 130 to enable the modified content to be provided to client devices 102-104.

As such, content provider device 111 represents any source of content that may be eligible for advertisement insertion, including, but not limited to television content providers, or providers of other forms of multimedia content.

Devices that may operate as ad insertion device 113, ad requester device 114, load balancer 115, ad marketplace ad servers 140-141, and/or ad marketplace web servers 150-151, include, but are not limited to personal computers, desktop computers, multiprocessor systems, microprocessor-based or programmable consumer electronics, network pcs, servers, network appliances, and the like.

Wireless network 110 is configured to couple client devices 102-104 with network 105. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

Network 105 is configured to couple various network devices with other computing devices, including through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router, such as routers 130-131, acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

Message router 130 represents virtually any network device that may be used to receive and to route messaging traffic through network 105 and/or wireless network 110. In one embodiment, message router 130 is configured to monitor for various content headers, tags, or the like, to determine whether the content is identified as “ad eligible.” If message router 130 determines that content is “ad eligible”, message router 130 may interact with ad insertion device 113 to modify the content with one or more advertisements. Message router 130 may then route the content to one or more client devices 101-104.

Ad insertion device 113 represents any device that may be configured to interact with message router 130, or other message routers, to provide the functionality of inserting an advertisement into text or media content, such as mobile terminate SMS text messages, directed towards client devices 101-104. In one embodiment, information is provided to ad requestor 114 about the intercepted content. Ad requester 114 then chooses the con-ect external ad server to interact with (140-141, or any of 160), and sends the ad request to that server to obtain advertisements. Ad insertion device 113 may then insert the received advertisement into the message for router 130 to complete processing and sending of the modified content over the networks.

Thus, ad requester 114 may be considered as an interface agent that facilitates communication between message routing platforms and external advertising providers.

As part of the publisher and advertiser interactions, Ad Marketplace data servers 140-141 store information about message inventory, store specific ads-text or content, and associate specific ads with specific inventory. The Ad Marketplace ad servers serve the appropriately matched ad content in response to the query from ad requester 114, or the like. In one embodiment, Ad marketplace data servers 140-141 may also be configured to instruct ad requester 114 to seek advertisements from another source, such as one of the external ad network devices 160, or the like.

Ad marketplace web servers 150-151 provide web interfaces to enable publishers and advertisers to perform the actions as described above, and below for managing inventory and advertisements for the inventory and performing administrative functions.

Devices that may operate as ad insertion device 113, ad requester 114, ad marketplace ad servers 140-141, and/or ad marketplace web servers 150-152 include, but are not limited to personal computers, desktop computers, multiprocessor systems, microprocessor-based or programmable consumer electronics, network PCs, servers, network appliances, and the like.

In one embodiment, the ad requestor device 114, operates as a complete ad requester/ad server by serving ads from its internal ad stock 170, and having no interaction with any external ad servers.

It is noted that in one embodiment, message router 130's functionality may be incorporated with ad insertion device 113 rather than operate as distinct a device. Thus, it should be noted that FIG. 1 is not to be construed as narrowing the scope of the invention, and other configurations, arrangements, or the like, of various devices may also be employed.

In one embodiment, various functions may also be identified for managing system 100 of FIG. 1. For example, in one embodiment, a super-user function may be defined that includes under it, an advertising agency, a publisher agency, and an administration agency.

In one embodiment, the advertising agencies are provided that enable online creation and test of mobile advertisement campaigns. Moreover, they can play around with numerous creative ideas on a test bed. Publisher agencies help media publishers to create, showcase, and sell their mobile content inventory, whether it is SMS, MMS, video poll, trivia, an alert, or the like, and to manage the process related with publishing of inventory. The administration agency provides an interface for monitoring various aspects of system 100 with many features including yield management where administrators can control aspects of a campaign and/or inventory.

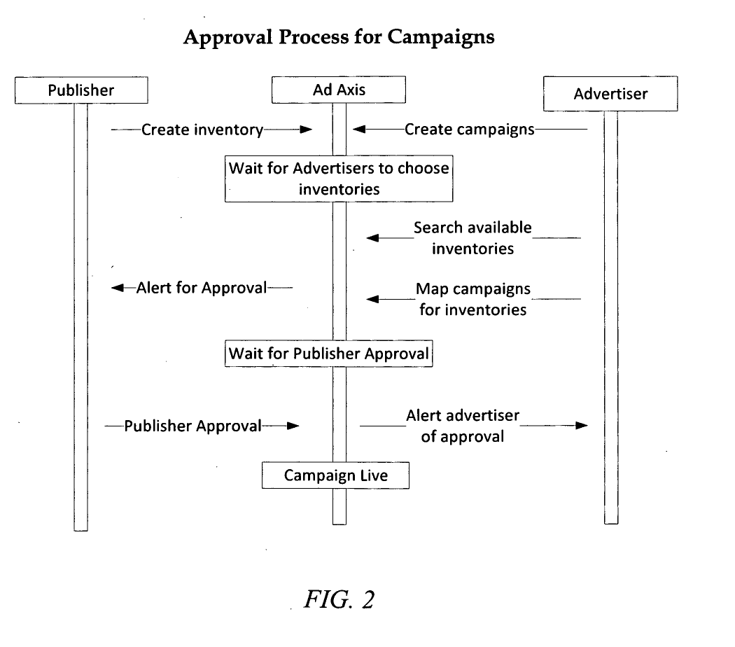

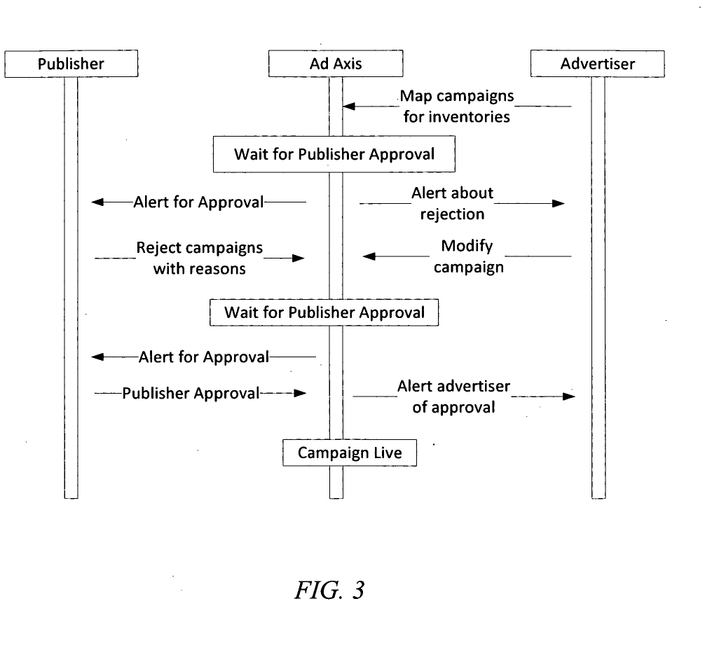

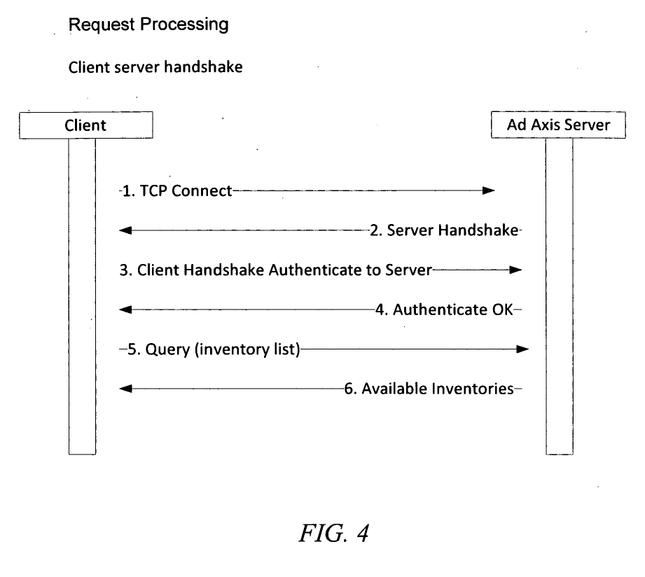

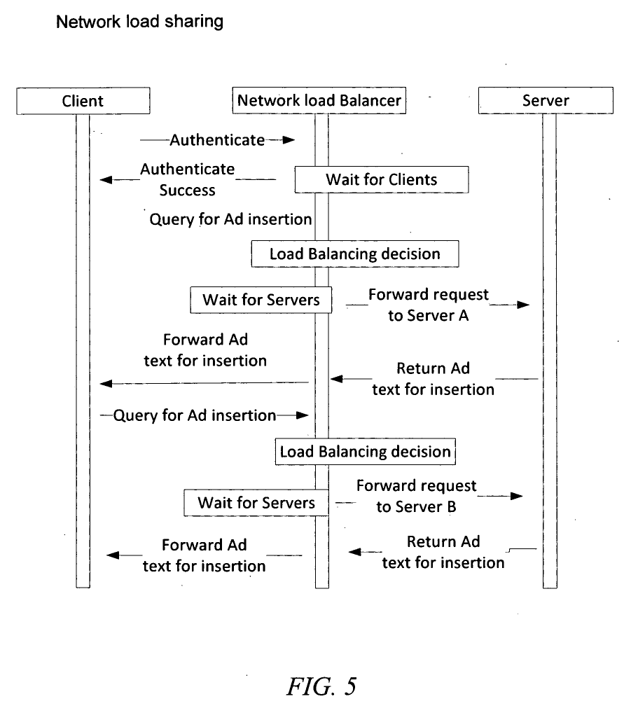

In one embodiment, ad marketplace data/ad servers 140-141 and ad marketplace web servers 150-151 may be referred collectively as the ad axis. Core functions of ad axis may be to include approved inventory ID and content loaded to ad axis; provide inventory information to a client device; serve ad requests by router/ad inserter inventory ID; perform ad matching and serve ad content; serve default ad content if no content is available; and as noted above, redirect to third party (external) ad network devices as appropriate. FIGS. 2-3 provide various flowcharts of processes, useable with system 100. For example, FIGS. 2-3 illustrate one embodiment of process flows for approval of campaigns. FIG. 4 illustrates one embodiment of a process flow for request processing with client server handshakes. FIG. 5 illustrates one embodiment of a process flow for use in network load sharing, such as may be employed by load balancer 115, or the like.

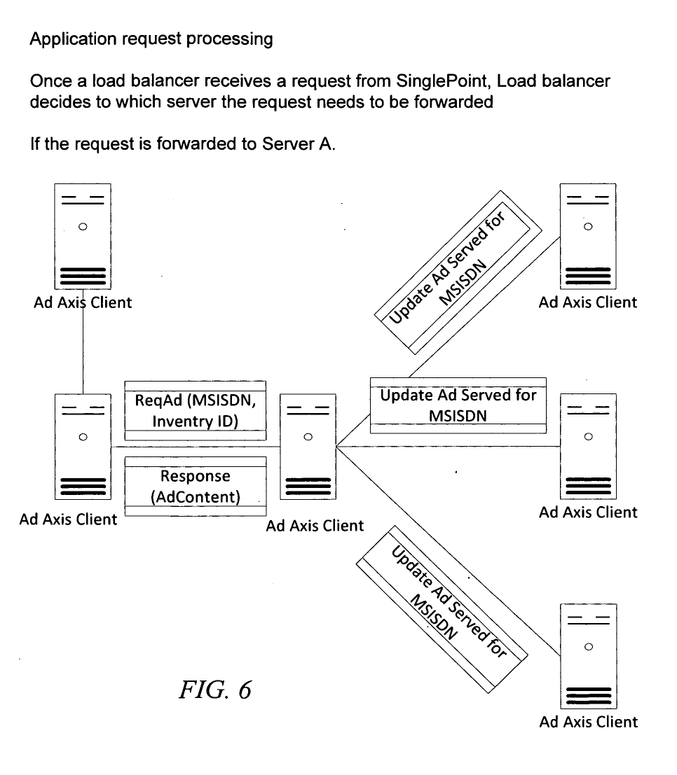

FIG. 6 illustrates further that once load balancer 115 receives a request, the data/ad server to which to send the request is selected. The selection may be based on any of a variety of load balancing criteria, and/or mechanisms, including, for example, throughput load, round robin, availability, or the like. In FIG. 6, for example, a request might be forwarded to server A. Thus, as shown, 1) a query may be performed of its local database residing on server A (of FIG. 6), for ad content for the inventory ID requested; 2) a check may then be performed of a tbl_processed_ad_requests on server A, for served ad content to avoid repetitions; 3) if an ad is served previously, then the new ad content is fetched; 4) respond to Ad content; and update tbl_processed_adrequests on all servers A, B, C, and D with MSISDN, and ad content served.

Overall, the components of the ad marketplace web servers 150-151, as well as data/ad servers 140-141, ad requester 114, and even ad insertion device 113, may be configured to provide security that authenticates and allows only registered entities, such as publishers, advertisers, and administrators to perform actions using such devices. A log of a user's actions may also be maintained. In one embodiment, data loading from web servers 150-151 to data/ad servers 140-141 may be performed an a regular basis, such as every morning at 12 AM, where all inventories which is intended to be live for a particular day may be loaded to all ad axis data/ad server's databases.

Illustrative Network Device Environment

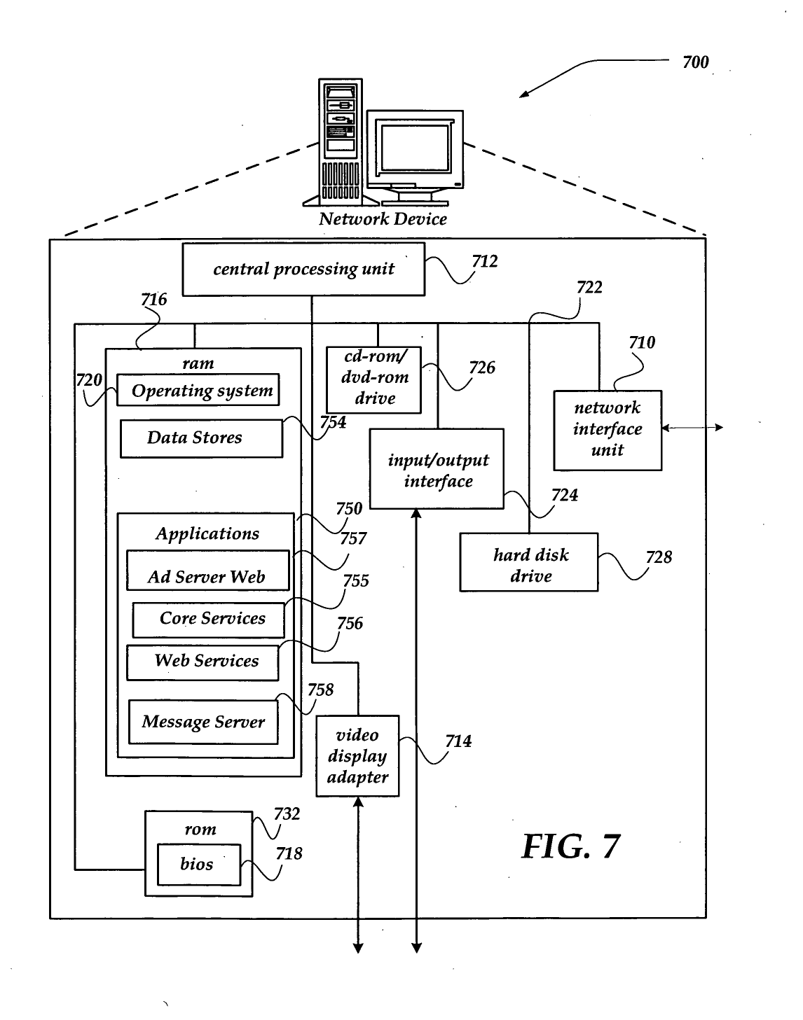

FIG. 7 shows one embodiment of a network device, according to one embodiment of the invention. Network device 700 may include many more components than those shown. The components shown, however, are sufficient to disclose an illustrative embodiment for practicing the invention. Network device 700 may represent, for example, an integrated network device useable for core servers 140-141 and web servers 150-151 of FIG. 1.

Network device 700 includes processing unit 712, video display adapter 714, and a mass memory, all in communication with each other via bus 722. The mass memory generally includes RAM 716, ROM 732, and one or more permanent mass storage devices, such as hard disk drive 728, tape drive, optical drive, and/or floppy disk drive. The mass memory stores operating system 720 for controlling the operation of network device 700. Any general-purpose operating system may be employed. Basic input/output system (“BIOS”) 718 is also provided for controlling the low-level operation of network device 700. As illustrated in FIG. 7, network device 700 also can communicate with the Internet, or some other communications network, via network interface unit 710, which is constructed for use with various communication protocols including the TCP/IP protocol. Network interface unit 710 is sometimes known as a transceiver, transceiving device, or network interface card (NIC).

The mass memory as described above illustrates another type of computer-readable media, namely computer readable storage media. It should be further recognized that computer readable storage media might also be known as processor-readable storage media. Computer readable storage media may include volatile, nonvolatile, removable, and non-removable media implemented in any method or technology for storage of information, such as computer readable instructions, data structures, program modules, or other data. Examples of computer readable storage media include RAM, ROM, EEPROM, flash memory or other memory technology, CDROM, digital versatile disks (DVD) or other optical storage, magnetic cassettes, magnetic tape, magnetic disk storage or other magnetic storage devices, or any other physical medium which can be used to store the desired information and which can be accessed by a computing device.

The mass memory also stores program code and data. For example, mass memory might include data stores 754. Data stores 754 may be include virtually any mechanism usable for store and managing data, including but not limited to a file, a folder, a document, or an application, such as a database, spreadsheet, or the like. Data stores 754 may manage information that might include, but is not limited to publisher web pages, advertiser web pages, advertisements, inventory, metrics, or the like, as well as scripts, applications, applets, and the like.

One or more applications 750 may be loaded into mass memory and run on operating system 720. Examples of application programs may include transcoders, schedulers, calendars, database programs, word processing programs, HTTP programs, customizable user interface programs, IPSec applications, encryption programs, security programs, VPN programs, web servers, account management, and so forth. Applications 750 may include web services 756, Message Server (MS) 758, Ad Axis web 757, and core services 755. Various actions of Ad Axis web 757 and core services 755 are described above and below in conjunction with other figures. Other applications may also be included.

Web services 756 represent any of a variety of services that are configured to provide content, including messages, over a network to another computing device. Thus, web services 756 include for example, a web server, messaging server, a File Transfer Protocol (FTP) server, a database server, a content server, or the like. Web services 756 may provide the content including messages over the network using any of a variety of formats, including, but not limited to WAP, HDML, WML, SMGL, HTML, XML, cHTML, xHTML, or the like. In one embodiment, web services 756 provides publishers, administrators, and advertisers with various web interfaces for managing the ad marketplace actions, based on a given role.

Message server 758 may include virtually any computing component or components configured and arranged to forward messages from message user agents, and/or other message servers, or to deliver messages to a local message store, such as data stores 754, or the like. Thus, message server 758 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, or the like.

Generalized Operation

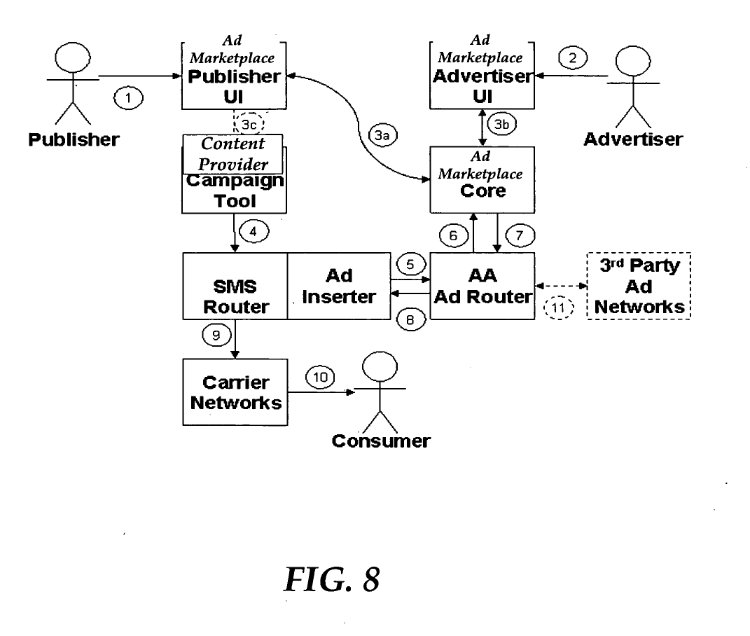

The operation of certain aspects of the invention will now be described with respect to FIGS. 8-21. However, it should be noted that other configurations, arrangements, and components may also be employed. Thus, FIGS. 8-21 (and 1-7) should not be construed as limiting the scope of the invention, but merely provide various aspects and embodiments for making and using the invention.

In any event, FIG. 8 illustrates one embodiment of a general top level system overview of a process for employing the system of FIG. 1. As shown in FIG. 8, the following steps may be performed: (1) Publisher creates inventory; (2) Advertiser Purchases Inventory and Creates Ad Content (note timing of tasks 1, 2, and 3 may vary). (3a, 3b) Inventory ID loaded into Ad-Axis, Ad Content adDed into Ad-Axis, Iterative ad approval process performed. (3c): Phase 2 task: Inventory information automatically loaded into Content Provider. (4) Client campaign tool initiates an MT SMS message. Message may be tagged for ad insertion based on presence of inventory ID. (5) Ad Insert Agent (AIA) queries Ad Agnosticator (AA) for ad content using inventory ID. (6) AA queries Ad Axis data/ad for ad content. For High Capacity campaigns, AA has the capability to receive content plus number of impressions and then store, serve, and count the impressions itself until it is time to query Ad-Axis again. (7) Ad Axis data/ad server performs ad matching and returns ad content. If a campaign is High Capacity, Core can return ad content plus a number of impressions to use the ad content for. Info ad content is available, a preloaded 3rd party ad network query string can be returned. (8) AA returns. Ad content. (9) Ad Insert Agent (AIA) inserts the content of the ad into the message and the message router routes the message to the appropriate carrier network (10) SMS MT with ad inserted is delivered to the Consumer. Optional task. If Ad Axis returns a 3^{rd} party ad network query string to AA, then AA queries the 3^{rd} party network and returns resultant ad content. AA sends a confirmation that the ad was served to Ad Axis data/ad servers. Optional task. If the advertiser has specified a confirmation URL, then external processes will use that URL to let the advertiser (or URL's owner) to count impressions served.

As discussed above in conjunction with FIG. 1, and further illustrated in FIG. 8, there are several system components. Thus, the Table below provides an additional brief functional description of at least some of the components.

| Name | Function |
|---|---|
| Content | Create, edit, and manage campaigns. Initiate MT SMS messages. |
| Provider | Includes ability to associate an Inventory ID with an MT message. |
| XIR | Message router for both MO and MT SMS messages. Includes ability to |
| | route messages with an associated Inventory ID to Ad Inserter for ad |
| | placement. |
| Ad Insert | Adjunct to XIR used to physically combine the externally provided ad |
| Agent (AlA) | text with MT SMS message text. |
| Ad Axis | earlier name for AdMarketplace forming the foundation to be used to |
| | create Inventory and Ad Content and to match Inventory and Ad Content. |
| | Master for Inventory ID creation and manipulation. |
| Ad | Middleware designed to: -query 3fd party ad networks for ad content - |
| Agnosticator | return a single ad content for multiple SMS messages during high |
| (Requester) | capacity campaigns |
| (AA) | |
| 3fd Party Ad | External ad networks that may be used as secondary and tertiary ad |
| Networks | content sources for some Inventory IDs. In one embodiment, DART is |
| | currently being used by NBC for WAP banner ad placement. |
| Carrier | For Example, Verizon and Sprint are CDMA. ATT and T-Mobile are |
| Networks | GSM. Smaller carriers may be a mix. |
| SingleVision | SingleVision includes a Data Warehouse and the associated reporting |
| | tools. |

The Ad Axis data/ad server described above in conjunction with FIG. 1 may provide a database engine that is responsible for storing inventory, and content, matching content with inventory, and serving appropriately matched ad content in response to an external query. Further, as noted above, various web based interfaces are provided including: Publisher GUI—Web UI used by people in a Publisher role to create, edit, sell, and manipulate Inventory Items. Advertiser GUI—Web UI used by people in an Advertiser role to create, edit, purchase, and manipulate Ad Content. Administrator GUI—Web UI used by people in an Administrator role to create, edit and manage users, roles, and account information.

Several user roles are defined for use in system 100, including: Publisher: One who creates, manages, and sells inventory items. Advertiser: One who creates, manages, and submits ad content as part of purchasing inventory items. Administrator: One who manages the system and users of the system.

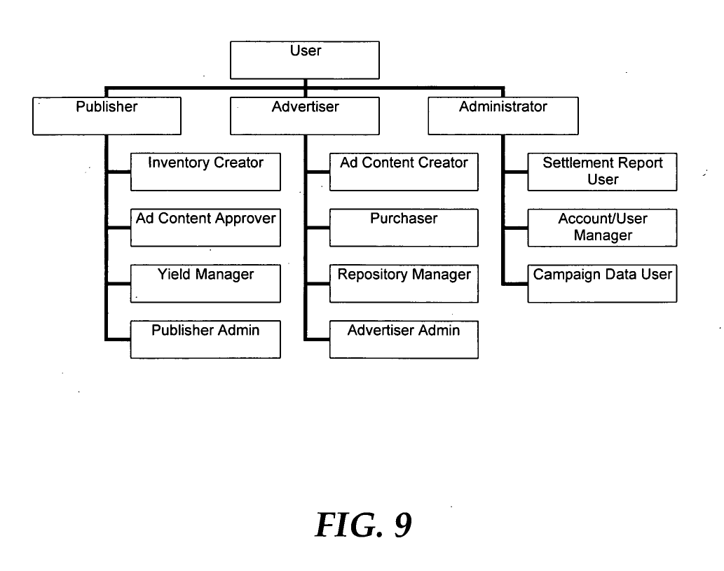

In one embodiment, there are sub-roles defined as well. The overall map shown in FIG. 9 provides one embodiment of at least some of the possible sub-roles. However, the invention is not constrained to these and others may also be included. In any event, examples of functions of some of the sub-roles are described further below:

| Role | Subrole | Functions |
|---|---|---|
| Publisher | Inventory Creator | Enter inventory data to the system. This |
| | | may need to be split in to data entry and |
| | | data publishing roles. |
| Ad Content | | Review and approve ad content submitted |
| Approver | | by advertisers to be used for an IID |
| Yield Manager | | Monitor usage and adjust the priorities of ad |
| | | content in real time |
| Publisher Admin | | Administrate publisher users accounts |
| Advertiser | Ad Content Creator | Enter ad content data either for a specific |
| | | IID or to become a repository item. |
| Purchaser | | Discover inventory items and submit ad |
| | | content to purchase inventory. |
| Repository Manager | | Manage the overall repository of the |
| | | particular advertiser. |
| Advertiser Admin | | Administrate advertiser users accounts |
| Administrator | Settlement Report | View/use settlement data to facilitate |
| | User | settlement between advertiser and publisher |
| | | accounts. |
| | AccountIUser | Manage accounts and users for top level |
| | Manager | publisher and advertiser accounts. |
| | Campaign Data | View IID and associated Content data to set |
| | User | up campaigns in Content Provider. |

Login Names and Process

Login Name. In one embodiment, the login name used includes the user's contact email address. This may be most consistent with long term plans for user access. The user should never be able to change their login name/email address since this is often tied to their company and have repercussions on their access type. Only an admin user is allowed to change email addresses. However, the invention need not be constrained to email addresses for login information, and other login names may also be used.

Account Creation Flow. One embodiment of a basic process that may be used for all types of account creation (publisher, advertiser, admin) is described below. The process for account creation may include: admin logs in; admin selects create function; admin enters user information; admin selects the “commit”, “create user” or other labeled execute button; a system email is sent to the new user with login instructions. The first login that the user makes, they shall be required to change their password, in one embodiment,

Login Security. Users may be given 3 attempts to login using their login name and password. If they fail, then, in one embodiment, they may be required to contact their admin to reset their login.

Forgot Password Function. Each user shall have a link to the “forgot” password function. In the event that the user clicks on this link, one of the following may happen: the user should receive an email with their new password that they must reset on their first login or the user should be asked a security question that they have previously entered the answer to. If they answer successfully (3 tries max), then they are logged in and taken to the first login screen where they must reenter their password.

Inventory ID Format. Inventory ID (IID) represents one unit element of the ad serving system. Inventory ID is used as the master reference for all of the information required to create, track, purchase, and serve ad content. The IID format is based on the expectation that the majority of their inventory will come from large media houses. One embodiment of the IID format is: <Publisher><Business Unit><Campaign or Show><Inventory Item or Episode>. Some examples are: NBC-SciFi-StargateAtlantis-Episode45. This is an example for inventory to be offered by the SciFi channel business unit of NBC for the tv series Stargate Atlantis for the show numbered episode 45. In this case, there is only one mobile ad campaign to be offered for that particular episode. NBC-SciFi-StargateAtlantis-Episode45A. This is an example for inventory to be offered by the SciFi channel business unit of NBC for the tv series Stargate Atlantis for the show numbered episode 45 for the campaign A. In this case, there may be more than one mobile campaign offered for episode 45 so a separate IID is created for each unique campaign. NBC-News-BreakingNewsAlerts-March. This is an example for inventory to be offered by the News business unit of NBC for the campaign breaking news alerts for the month of March. Textaday-Textaday-Green-Target. This is an example for inventory to be offered by the Textaday Publisher. Textaday does not have multiple business units so Publisher and Business Unit are the same. The inventory is offered for the Green Campaign and the Inventory Item name is Target. Typically, it may be rare to display the entire IID name, but should use the data within the various fields to improve human readability and usability.

IID Field Names. <Publisher> In one embodiment, this is defined by the login name of the user. <Business Unit> In one embodiment, this is a dropdown (or similar) that is defined by the publisher admin. It may default to the value defined by the login name of the user (presumably in a profile of some type). <Campaign or Show> and <Inventory Item or Episode> may be freeform text fields. In one embodiment, as the user types, these fields have drop downs that dynamically filter themselves to items that match the typed string so that the user can click to auto-complete rather than having to type the entire string. This also allows the user to enter a completely new string. The desired functionality is essentially the same as the auto-complete/auto-fill function used by Excel. In one embodiment, there may be additional field included to denote multiple campaigns, such as for example, episode 45-A, episode 45-B, or the like, that may have more than one campaign associated with them. In addition, extra fields may be included to cover time zones, and/or possibly different days of scheduled alerts and/or ongoing campaigns. For instance, an episode of a television show may air 4 times (once at 8 EST17 CST, once at 7 MST, once at 8 PST, and once in Alaska and/or Hawaii). The same show and campaigns may run with different demographics each time. In the case of an ongoing campaign or scheduled alert, an additional field may be included to note the sequence number (equivalent to date, in one embodiment) so that we can sell and display status of the IID. In still another embodiment, a delivery type field may be included based on mobile delivery types of campaigns. For example, where there are both an SMS and MMS campaign, the delivery type field may identify these two campaigns. Moreover, in one embodiment, users may be enabled to manage the multiple IIDs associated with a single episode that has multiple campaigns or delivery types. Additionally, at least some of the fields may have predefined maximum field lengths, a set of allowed characters, or the like.

Ad Commerce Concepts

Settlement. In one embodiment, the ad axis (comprising the ad marketplace core servers 140-141, and ad marketplace web servers 150-151 of FIG. 1) may be configured to facilitate settlement of payments between publishers and advertisers. As such, ad axis may include the ability to tie users to settlement account activities. In one embodiment, a report may be exportable in CSV format to allow easy manipulation of accounting data. In another embodiment, the ability to auto populate an invoice template may be provided. In one embodiment, the ability to have a settlement interface is also provided that interfaces with standard accounting software, including such as Great Plains, Quickbooks, or the like. In addition, prepaid account balances may be established for advertisers, including setting up a credit card payment mechanism for various accounts. In one embodiment, the ability to change/set the amount of credit may also be provided. For example, in one embodiment, a credit status for an account may be provided that includes information such as whether the account must be prepaid, credited up to a defined amount, or the like.

Credits. In one embodiment, a user credit function is provided for: forecasted inventory that is purchased by advertisers but does not become available; purchased inventory that is unusable due to delivery issues; inventory that is made available by Publishers but not usable due to delivery issues or possibly due to no sales made against it.

Price Negotiating. A mechanism may be provided to facilitate price negotiations between Publishers and Advertisers. For example, in one embodiment, the invention provides an ability for Advertisers to bid on a piece of inventory and for publishers to pick between multiple bids and also to negotiate/ask for a higher price than was bid.

Approval Cycles. A need to rapidly support content approval cycling between publisher and advertiser is needed. This is particularly true during the last few days/hours prior to a campaign beginning. Success of this function may be tied to the implementation of the notification system discussed below. In another embodiment, the invention may allow publishers to establish a lockout time for an IID that is defined as the last time that ads may be reserved CONFIRMED as a requirement. In addition, a countdown clock or something similar may be shown to advertisers.

Allowable Inventory/Ad States. Possible states for content and inventory, include the following examples. “Defined,” i.e. inventory is considered defined if it has been created and saved, but not yet published. It does not require all fields to be complete for this state to be achieved. Ad content is considered defined once it has been saved to the repository. “Published,” i.e. inventory that has been defined and made available to advertisers for discovery and purchase. “Reserved,” an advertiser can reserve inventory prior to associating ad content with it. The reservation should have a limited timeframe before it either expires or the advertiser must associate ad content and submit it for approval. “Pending,” may refer to inventory/ad content pairing is in the pending state once an advertiser has submitted the content to the publisher for approval. “Approved” may be used to denote the publisher has approved the ad content for use with one of more pieces of inventory. The content is now available to be served up by ad axis at the appropriate time. “Rejected,” can be used when ad content has been rejected by the publisher. Rejection should be accompanied by a reason for rejecting the content and steps to correct the issue where appropriate (i.e. some ads may be rejected due to the product and can't be corrected, but others may need only a wording change.) Probably if ad content is rejected categorically then this state is appropriate. If ad content is rejected but the advertiser is notified that it will be reconsidered if certain changes are made, then the state should go to pending. “Expired,” may mean ad content that was never served and has expired. “Complete,” may refer to ad content that was served and is now complete.

Publisher Functions

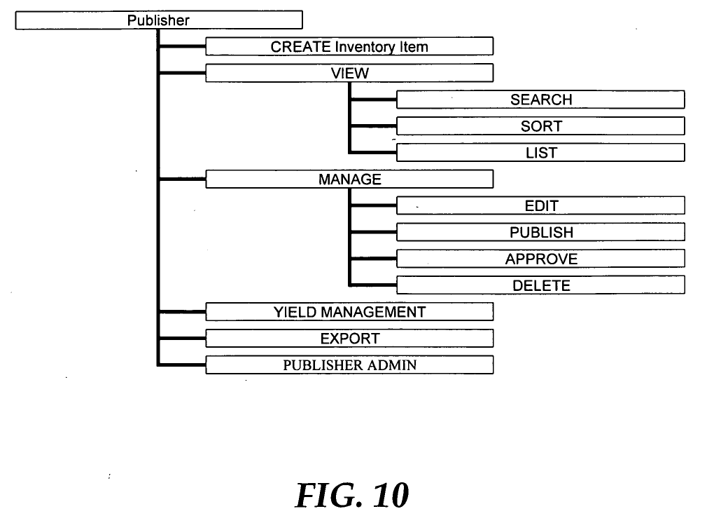

One embodiment of Publisher functions are illustrated in FIG. 10. However, other functions may also be implemented. Thus, FIG. 10 is not to be construed as narrowing the scope of the invention.

Create. The create function is used to create and define a new IID. Non-limiting examples of elements that are included as part of the IID definition, in one embodiment, are shown below.

| Element | Range/Values/Fmt | Definition | Notes |
|---|---|---|---|
| Inventory Name | Definable | Name for Inventory | This name will be |
| | | | used in creation of |
| | | | IID |
| Start | MMDDYY | The start time, date | |
| | HHMMSS TZ | and timezone of IID | |
| End | MMDDYY | The end time, date | |
| | HHMMSS TZ | and timezone of the | |
| | | IID | |
| Forecasted | Freeform number 1 | How many | |
| Impressions | | impressions are | |
| | | forecast for this IID. | |
| Type - Blind | Checkbox with | Blind ads are sold | Details include sold, |
| | details | with demographic | remaining, |
| | | and geographic data | dedicated values - |
| | | visible, but no | see more |
| | | publisher or | information below. |
| | | campaign data | |
| | | available | |
| Type - Open | Checkbox with | Open ads are sold | Details include sold, |
| | details | with complete | remaining, |
| | | campaign data | dedicated values - see |
| | | visible including | more information |
| | | demographic, | below. |
| | | geographic, | |
| | | publisher, and | |
| | | campaign/show | |
| Sales Type | CPM, CPC, Flat Fee | | |
| Floor Price | For each sales type | | |
| Ad Type | SMS, MMS, Banner, | | |
| | Video | | |
| Ad Size | Numerical | Units vary | Characters for SMS, |
| | | depending on ad | kb for MMS, |
| | | Type. | seconds. For video, |
| | | | pixel dimensions. |
| | | | For banner. |
| Exclusions | Complex - see notes | | |
| Audience - Demo | | | |
| Audience - Geo | | | |
| Genre | Definable | The genre of a tv | |
| | | show or campaign | |
| Daypart | Primetime, morning | | |
| | commute, etc. | | |
| Secondary Ad Net | Definable | | |
| Tertiary Ad Net | Definable | | |
| High Capacity | YeslNo | This show is a high | |
| | | capacity show | |
| Campaign Type | Definable | An area to set the | |
| | | campaign to be one | |
| | | of a number of | |
| | | predefined types | |
| | | (vote, trivia, alert, | |
| | | etc.) | |
| Reservation | | Validity time for a | |
| Timeframe | | reservation against | |
| | | this inventory. May | |
| | | be a dynamic value | |
| | | with declining | |
| | | values as the time | |
| | | prior to going live | |
| | | decreases. | |
| Inventory Type | Channel, Series, | Concept is to | |
| | Show? | designate inventory | |
| | | for sale against | |
| | | multiple IIDs that | |
| | | are associated. | |
| CTA Type | Brand, Reply, Link, | Certain publishers | CTA types are those |
| Restrictions | Call | restrict the | defined in the |
| | | allowable calls to | advertiser Create |
| | | action. | section. |
| Allowed Campaign | 0-100% | This is the | |
| Percentage | | percentage of a | |
| | | single advertiser's | |
| | | campaign that can | |
| | | be placed against | |
| | | one or more IIDs. | |

Blind, Half-Blind and Open Types. There is provided graphical drag and drop types of controls as well as some graphical displays of the values. The figures below show some ideas as possibilities. The first figure may be seen as most basic, text based, representation of the values.

There may be a default to open unless the publisher has selected a different default at either the publisher level or the business unit level. In order to simplify management of blind and open, the don't care category has been eliminated. The total of blind and open allocated inventory may equal 100% of the forecasted inventory. The “half-blind” category, is provided as some shows may be sold with advertisers allowed to know that the inventory is from a particular publisher, but not allowed to know any other information. In one embodiment, the term “blind” to refers to inventory where the advertiser is not allowed to know any details about the inventory beyond date ranges and content type (sms, etc.). In the first figure, the number of dedicated/allocated blind+the number of dedicated/allocated open must now equal 100. See below for examples:

| Example 1:100 | | | |
|---|---|---|---|
| Forecast | Allocated | Sold | Remaining |
| Blind | 20 | 0 | 20 |
| Half-Blind | 30 | 0 | 30 |
| Open | 50 | 0 | 50 |
| Blind | 20 | 10 | 10 |
| Half-Blind | 30 | 20 | 10 |
| Open | 50 | 30 | 20 |

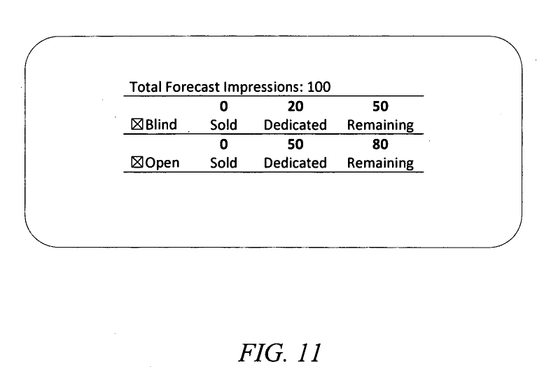

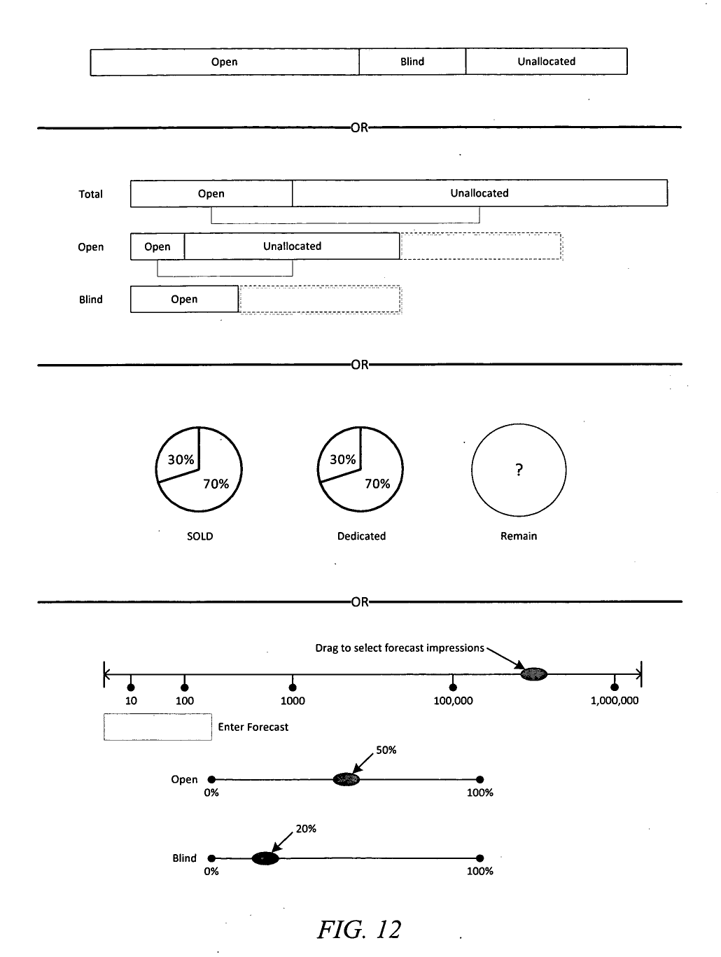

FIG. 11 shows some samples of possible display mechanisms for basic blind/open value representations, while FIG. 12 provides one embodiment of a blind/open display of options.

Sales Type. In one embodiment, CPM, CPC, and Flat Fee are provided. In addition, may enter a floor price in the appropriate units for whichever is selected. In another embodiment, may include a currency type.

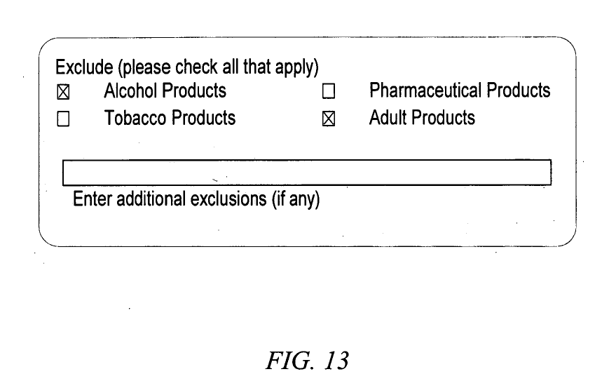

Exclusions. Exclusions may be a complex field. This may include, in one embodiment, a set of predefined categories (adult, alcohol, tobacco products, etc.) that can be selected via checkboxes, plus a standard setting that is defined for the entire publisher and/or business unit, plus a free text area for this IID. One non-limiting example of an exclusion interface is illustrated in FIG. 13.

In the case of a blind piece of content, the exclusions could give away information associated with the content (for instance if NBC says no ABC, FOX, or CBS advertising it would pretty much reveal that NBC is the publisher). It may be up to the publisher to be aware of this, in that the exclusions might not be hidden, in one embodiment, from advertisers for blind IIDs. In one embodiment, the addition of Exclusion may be restricted to Super Admin, instead of allowing publishers to do. A publisher might specify a carrier exclusion for the following 2 reasons: 1) They are publishing inventory that is sponsored by a carrier and therefore exclude all of the other carriers from participating; 2) They are publishing inventory that has not been approved by one or more carriers and therefore the non-approving carriers are excluded. Treatment of carrier exclusions from a publisher may be to accept the input, associate the exclusion with the IID, and use that where warranted in the advertiser search/discovery functions. Below provides additional information regarding Carrier exclusion may be in the advertiser section.

Audience Demographics. Demographics may be defined using the same range groupings that Nielsen uses. May also provide an import function for ratings data here that may also recognize that new shows may not have ratings data available and that ratings data that is available may be for past episodes. Thus, the rating data may include an ability to be edited.

Audience Geographies. Geographics may begin with Country then drill down to Timezone, then State, Media Market, and potentially zipcode. State and Media market are separate, non-hierarchical attributes. For instance a campaign run against a tv show might be available in all states except for Georgia due to regulatory issues in Georgia. At the same time, the show might be available only in 85 of the top 100 media markets due to the network it is on or the time slot, etc. Geographic selection is an area may include a defined selection process.

Forecasted Impression Notes. In one embodiment, for a scheduled alert or similar campaign: the forecast impressions may be the number for one unit of the campaign (i.e. 1000 impressions per day expected for a daily alert). The user might only need to fill this in once and then the same number will be used every day until the user goes in and updates it. Additionally, the actual impression data may be used to notify the publisher if they need to change the forecast. In one embodiment, for a TV Show, if forecast impressions are entered for the overall show, then the impressions may be automatically apportioned to a time zone using the general population ratios between time zones.

IID Definition Display Notes. There may be several approaches to IID definition. At its simplest, the definition can be a series of grouped text entry and check box forms. That would be enough to provide the required functionality. In another embodiment, a selection may be provided for the IID that defines whether it is a tv series. If it is, then there are some fields that can be automatically filled. Going back to the IID format, the moment the IID is known as a show as opposed to a campaign then the invention can allow the user to set up the times similarly to the way Outlook allows a user to set up a recurring meeting (start date, every day at ??? from ???pm to ???pm for x occurrences). Demographic data may also be defined at a show level as well. In one embodiment, the data that is defined at show level may be used to auto populate the episode/IID level records.

CTA Restrictions. Some publishers may select to restrict the allowable calls to action. For example, the NBC News business unit might only allow calls to action that are Brand or Reply CTAs. They might not allow Link or Call CTAs. CTA Restrictions may be defined at a business unit level as a default with exceptions allowed for individual IIDs. There may also be an advanced section in the IID definition sequence to allow for the exceptions to be made.

Allowed Campaign Percentage. This may, in one embodiment, be a restriction that publishers may place upon advertisers to ensure that the advertiser is not exclusively targeting inventory from a single publisher. In one embodiment, the publisher specifies an allowed campaign percentage for an IID (or at the publisher or business unit level). The advertiser can purchase only that percentage of their campaign from the specified IID. For instance, NBC currently imposes an allowable campaign percentage of 50% on Jumptap. This may, for example, be imposed across the entirety of the NBC properties. Jumptap can run a campaign and search for inventory but they are only allowed to purchase 50% of the total campaign from NBC inventory. This requirement implies a method of displaying the allowable percentage to the advertiser.

View. View functions are intended to provide easy navigation through the publisher inventory. There may be a variety of search, sort, and display functions available that allow a given user to quickly navigate to the desired data set(s). Below is one embodiment, of a Sample List View for a publisher showing IID information, time left until the sales period closes or until the show airs, or other relevant timing info, and sales data color coded for easy assimilation. The time info remaining field is intended to be meaningful from a “this is how much time is left until a publisher has to perform some action such as approving pending ads” standpoint.

In one embodiment, Sample List view for a recurring scheduled alert showing business unit, show, campaign name, and sales status can be provided. Security may be enforced at multiple levels for the view functions. In one embodiment, default rules and exceptions may be defined for business unit level access vs publisher level access.

Search. Search may be available as a free form text search parameter that is matched against virtually all data we have regarding accessible IIDS (i.e. not just an IID search, but also searching through exclusion text, note text, etc.). In one embodiment the advertiser search functions may also be available to the publisher as well.

Sort and Filter. Publisher may be able to sort and filter based on time, available impressions, sold impressions, current, past or future status, business unit, show or campaign, IID, etc.

List. The list and display of inventory items may provide an “at-a-glance” measure of the inventory sold vs inventory remaining for the desired set of IIDs. This may be graphical and also may allow calendar views of upcoming IIDs as well as list views. Sold vs remaining inventory may also allow aggregated views as well as individual IID lists. Various calendar views of tv episode IIDs may also be provided.

Track. Publishers may be able to designate certain IIDs that they wish to track. Method of tracking may be via either email or sms message, or both. If a publishers elects to track an IID, they may be sent a summary message showing number of impressions, number of uniques, and number of ads served. Timing of the message may be as follows: If an IID has a discrete end time such as will be the case for most high capacity campaigns associated with tv shows, then the tracking message may go out as soon after the end time as practical. If an IID is ongoing (daily alerts, etc), then the tracking message might go out following midnight in the last timezone (Alaska or Hawaii) and might contain data for the previous day. Publishers may be able to set up a default for the tracking function that specifies method of delivery as well as whether all lIDs in their business unit are tracked as a default or whether to default to no tracking.

Manage. IID management functions include the abilities to accomplish commercial transactions for the actual ad sales functions.

Edit. There may also be the capability to edit any of the fields that comprise the definition of an IID. There may also be a clone/save function that lets users save edited definitions in a template format for future use.

Publish. The publish function is to make the IID available for advertisers to purchase. Implied in this requirement is that one person in an account might enter all of the data, but not have the authority to actually approve the IID for publishing.

Approve. The approve function may allow the user to approve the submitted ad content to run as part of the Publisher's campaign. Thus, in one embodiment, there may be the role of an Approver and also a method of reviewing proposed ad content. There may also be a notification function. An advertiser may reserve some impressions against a particular IID and enter their ad content data and then click submit. At that point, the publisher may be notified that they have pending ad content for review and approval. Also, when a publisher approves the content, the advertiser may be notified. Finally, if a publisher has comments back that must be incorporated prior to approval, the advertiser may want to be expeditiously notified. Thus, the following notification options may be used: an inbox that shows new messages when you log in highlighting of IIDs that have notifications whenever they are shown in a list email notifications; text message notifications. One embodiment may include a tiered system for setting up notifications with admins able to set up distribution rules for some types of notifications and with individual users able to set up notification preferences in a profile area.

Delete. There may also be a way for publishers to delete pieces of inventory. If there are pending or closed ad purchases, then notification will accompany a deletion.

Yield Management. In one embodiment, yield management may be a real time function available to Publishers. Publishers can view a current campaign, see all of the ads purchased against the IID and track the number of impressions served. They can choose to adjust the results by changing the priority of one or more of the sold ads. They may also be able to move in other ads to meet credit needs or other internal requirements.

Export. In one embodiment, an optional function may be included to export IID data for use as an input to Content Provider. In one embodiment, a pop up may be provided with the various fields in free text so that users can be cut and paste into an Content Provider window. Alternately, an email the IID data for similar use may be provided.

Publisher Admin Functions

Personal Publisher Admin. The invention may provide standard login administrative functions including, but not limited to: change password and preferences such as mobile number; method of notification (inbox, email, sms); default timezone; and tracking defaults.

Group Publisher Admin. This set of functions allows a Publisher that has been designated to have admin capabilities to create, modify, and delete publisher accounts. Publisher accounts may inherit the access and roles of the parent account with the ability of the parent account to modify that be deselecting functions to disable them. Group admin will also be able to control Publisher wide and/or Business Unit wide preferences for exclusions and other settings. Reset users login status after the user has failed to login successfully 3 times.

Publisher Default/Landing Page. There may be 2 primary view pages for publishers. These are a calendar based view and a list based view. The initial page that a publisher sees once they log in may be one of these two views. They may be able to set which one in their profile and also to define some filter parameters that they default to in their profile. If a publisher does not establish a default view in their profile, then they may default to the calendar view with no filtering other than that imposed by their login credentials, in one embodiment. The initial page may notify the user of any notices that they must respond to.

Inventory Creation Flow & Display Concepts

Top Level Concept

One embodiment may provide an Outlook style of calendar display as the initial view that a publisher sees. The use may then navigate to view details of an IID by clicking on it or creating a new IID by clicking on a calendar timeslot. Given the top level, then the appropriate sub-elements can be used. As a display concept, one embodiment may include a multi sectioned page whereas the cursor moves over a section, it expands and comes to foreground for the user to enter data on. (the upper left “sci fi wire news” section of scifi.com has a small example of this.) One embodiment, might not include popups on top of popups ad infinitum.

Inventory Group. These groups drive the displays/data used for defining an IID. The Inventory Groups include: (1) Ad Hoc Alert Campaigns—these are alerts that are triggered in an asynchronous fashion. Examples could be a breaking news alert, an alert/message that is sent out because the end user responded to a magazine or internet ad, or an alert sent out to remind a viewer of an upcoming show. These alerts are characterized by a start date but may not have an end date; (2) Scheduled Alert Campaigns—these are alerts that are sent out with a predictable frequency and possibly at a predictable time (or time window). Examples of this might be a daily news alert, end of market stock quote, etc. These alerts are characterized by a start date, frequency, and time frame, but may not have an end date. (3) Ongoing Campaigns—these are campaigns that are more than a single event, but do not necessarily have the regularity of a scheduled alert campaign. Primary example is a television series. These campaigns are characterized by a start and end date with an irregular periodicity. They typically will be comprised of a number of single tv show campaigns; and (4) Single Event or TV Show Campaign—this is a campaign that runs during a fixed timeframe, typically from 10 minutes to 3 hours in duration, and then is finished.

Create IID Entry Groupings. The entries may be grouped into the following non-limiting related groups: (1) by time; (2) audience; (3) sales info; and (4) campaign info.

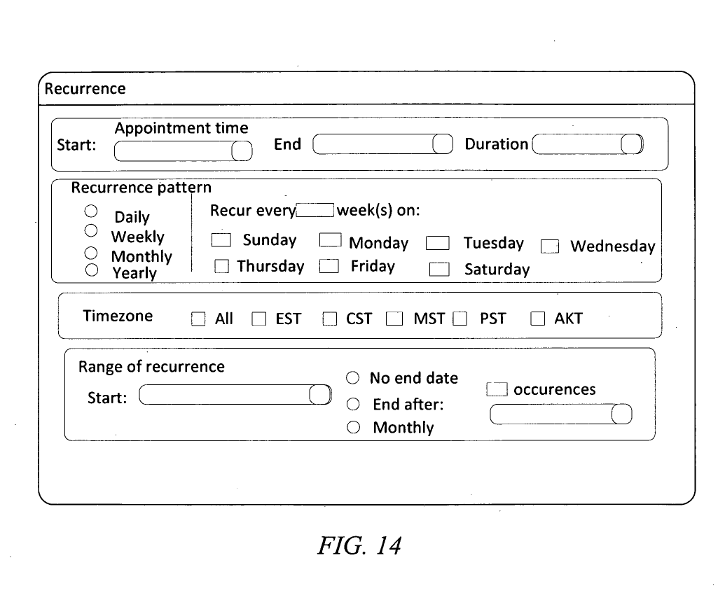

Sample Date Time entry for TV Series. If the user selects ongoing campaign then they are able to set up the dates for the series in an outlook like fashion. At that point, they are able to enter all of the data that applies to all of the episodes in the series. Finally, they may be given the choice to “create entries for each episode”. When they do that, then IIDs will be created for each of the individual episodes in the tv series using the global data that was entered for the series as a whole. User may be queried for the starting episode number of the sequence and then each episode are sequentially numbered. For example NBC-SCIFI-StargateAtiantis-401, NBC-SCIFI-StargateAtiantis-402. FIG. 14 provides one embodiment of an interface for managing exception cases for dates using appointment recurrence.

Advertiser Functions

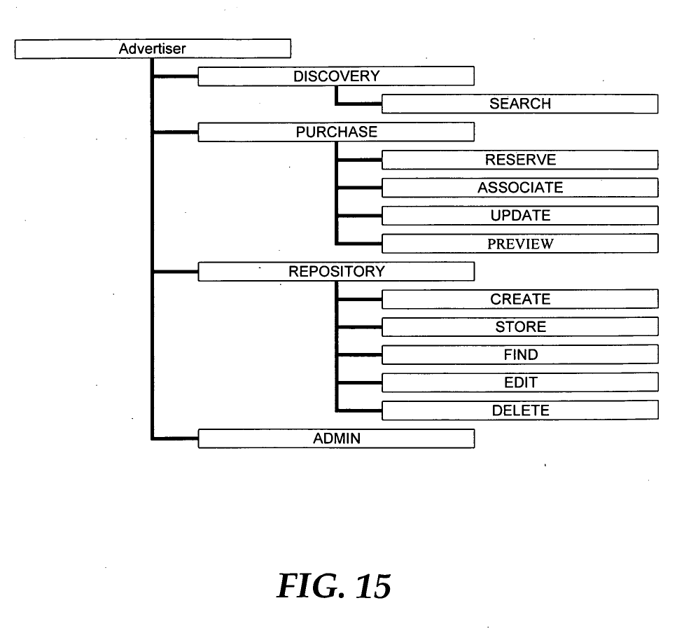

One embodiment of an advertiser function tree is shown in FIG. 15. Various relationships between an ad repository and the ad creation and purchase process may exist. In one embodiment, every piece of content may be entered into the repository before it can be used to purchase inventory. In another embodiment, it be created as part of the purchase process without using the repository (or may be entered into the repository automatically after the purchase).

Use Case Notes. Use cases consider advertisers attempting to discover and purchase the following types of inventory, including: A specific show, and A number of available impressions within a specific timeframe.

Ad Content vs Campaign Info. In one embodiment, the ad content definition may be separate from the campaign definition. More specifically, the ad content is the text, video, etc. that can appear in one or more campaigns. The campaign is the definition of which ad content to use and how to use the ad content in the context of a specific ad purchase. For example, if an advertiser were to discover and purchase 10,000 impressions of an upcoming DoND episode, they might define 2 pieces of ad content: “See your Toyota dealer to learn about our fuel efficient hybrids” and “Toyota Prius is the most fuel efficient hybrid on the market today”. These pieces of ad content might already be defined in the repository or they might need to be defined. The campaign information for the ad purchase may store the following: (1) use ad content (A) and (B) for this campaign. The campaign type will be Sequencing per User (see next note) meaning for each unique user, first serve up content (A) and then if that unique user participates in the campaign a second time, serve up content (B) and if that unique user participates in the campaign a third time, serve up A) again, etc. This campaign definition is the one to use for the DoND IID, in one embodiment.

Campaign Types. The campaign types may include: Round Robin; Sequencing per User; Random; Weighted; Stepped Rotation. Also, there may be up to 10 pieces of ad content that can be associated with a campaign.

Campaign Names/Campaign IDs. Campaign IDs may be formatted similarly to IIDs. They may be Company_BusinessUnit_CampaignName_Sequence where Campaign Name and Sequence are free text fields and Company and Business Unit are defined by the admin on setup.

Default View. The advertiser default view may be the My Campaigns view. The user is given the opportunity to change the default to one of the other views. For new users or users that have not defined any campaigns, they default view might be a welcome splash.

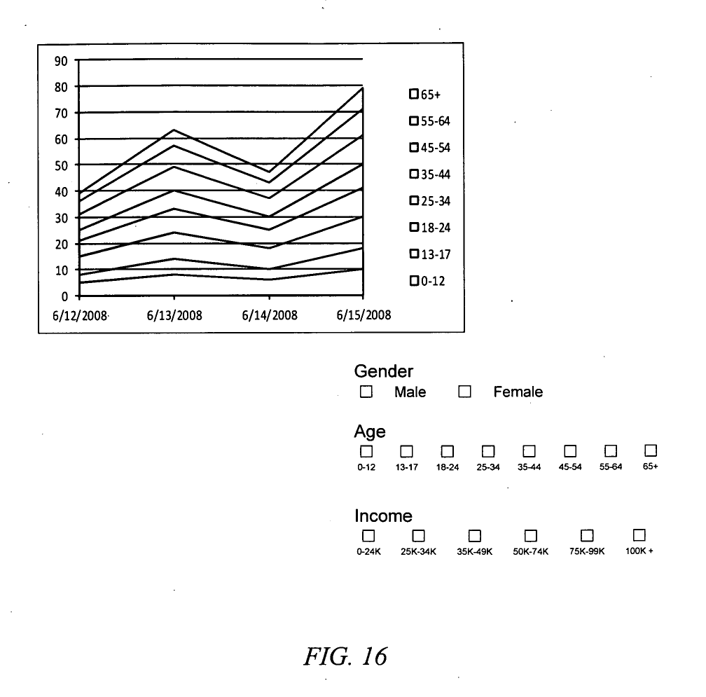

Discover. In one embodiment, a dynamic screen may use AJAX or similar technology that can allow the advertiser to rapidly drill down the list of available inventory by adjusting the demographic (and potentially geographic) parameters. FIG. 16 provides one embodiment, for an example of what this might look like.

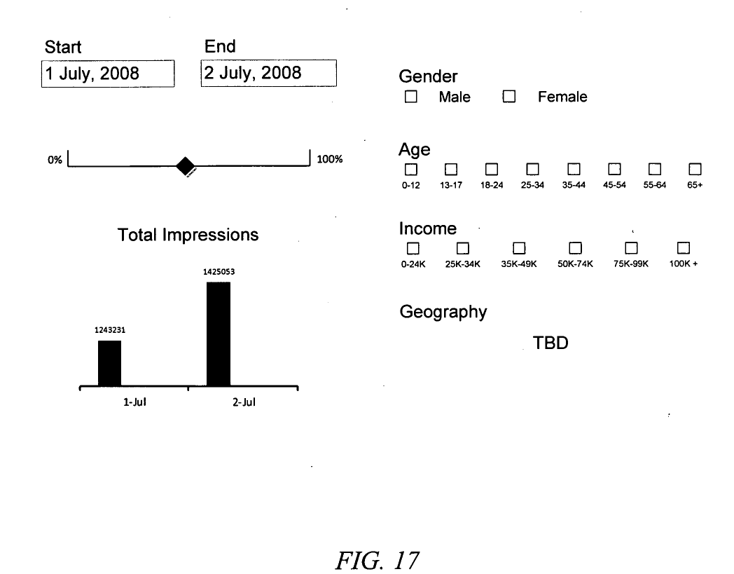

Discover Example for the Demographic section. FIG. 17 provides one embodiment of a discover example for demographic data. In one embodiment, a separate quality of match control is provided for each major axis (Gender, Age, Income). This way the advertiser can select the degree of match that they want in a more precise way. In one embodiment, separate displays are provided for each demographic axis with a tab method to switch between displays. One embodiment shows more explicitly the time based display of demographic data.

Additionally, Geographic controls may be provided, such as a mix of graphic and checkbox but the top level can probably be limited to timezone with a drill down to more refined geo definitions. May also provide a template Geo and or Demo definitions that are available from a pull down menu. In one embodiment, size of ad might not be shown, but, in another embodiment, such information may be included (characters, kb, pixels, seconds, etc.). Quality of match is an algorithm that may be provided. The definition is how close the Inventory defines geo and demo parameters. For instance, if a show specs out to be 70% Male and 30% Female and the desired target demo is Male, then is this a 70% Quality of Match?

Sequencing. Sequencing of data entry for the discover process may be as follows: (1) Start and Stop time entry; (2) Geographic and ad type entry; and (3) Demographic data entry.

Geographic & Type Info. Geographic coverage may default to national unless the advertiser at the business unit level has set a different default. One embodiment may enable a number of regional and local advertisers to enter default geographic data. Type entry may be to select type of ad from SMS, MMS, WAP, Video. Once type is selected the appropriate sizing selection may be made available. When an advertiser enters sizing data it may be interpreted as the minimum size required (i.e. if the advertiser selects MEDIUM for text length, then the discovery search should return both MEDIUM and LONG results).

Demographic Info. Demographic information should include the ability to set defaults at the business unit level for all demographic data (age, income, gender). Selection of demographic data should be via the data points used by Nielsen. That means there will need to be percentages assigned to each of the bins rather than the more simple slider mechanism shown in the demonstration. Along with the demographic info should be capability to enter price ceiling, price type and an advanced section that allows for the following: (1) carrier exclusions (for instance perhaps Sprint want to exclude all other carriers from its advertising or perhaps an Buongiorno mobile has been barred from Verizon and wants to exclude them from ads); (2) control over exclusions of competing brands or other unusual exclusions; and (3) for nontext ads, the ability to specify handset types smart phone, symbian, etc.

Carrier Exclusion. Advertiser carrier exclusion may occur for the following reasons, such as the advertiser is advertising a product or brand that one or more carriers will not allow to be advertised on their network (example: alcohol products) or such as one or more carriers do not support the product that is being advertised (example: Tmobile does not support a certain download format that is required to play the advertised mobile game.) In one embodiment, Ad-Axis may want to know the carrier of an incoming ad query. Thus, in one embodiment, carrier information might be added to the query/response mechanism in the AA:Ad-Axis interface. The method used may support high capacity requests as well as normal requests. In one embodiment, a QUI may allow both publishers and advertisers to enter carrier exclusions and store them in the database.

Search. In addition to the discover tools discussed previously, A text based search and display pages similar or identical to those needed for the Publisher functions may be provided.

Reserve. Advertisers are able to select from the results of either a search or a discovery action and reserve inventory for their ads. They may select the quantity to reserve and then either: associate ad content from the repository to the inventory; or be taken to the create ad content pages to create a piece of content. The reserve action may either: 1) allow a limited amount of time to associate the ad content and submit it to the publisher for approval or 2) let the advertiser commit to paying for the ad regardless of time (in other words they would agree to pay for all of the desired impressions whether or not they submit approvable content in time for the campaign to run). Confirmed in the case of blind content, may be able to reserve against a large block of inventory that came from multiple publishers. When this occurs, separate approval actions from separate publishers are provided. If an advertiser commits to an ad purchase, then they may enter a Purchase Order number for that purchase. A method for the business unit to enter purchase order information and tie it to ad campaigns may also be provided. The reserve action may be a double opt in action. The user may click on Reserve or Commit and then be prompted with “are you sure you want to Reserve/Commit this ad buy? Click Yes to continue or cancel to . . . ” or some similar words. Following the reservation, the campaign may be added to the my campaigns list for this business unit/user with the name Company_BusinessUnit_Unamed_NNN where NNN is a sequence number.

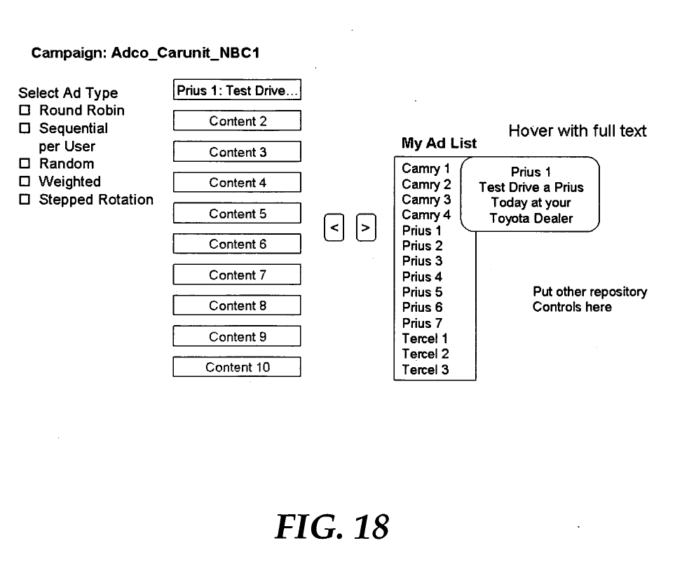

Associate-Define Campaign. Functionality may be provided to select ad content from the repository and associate it with the inventory item(s). FIG. 18 provides one embodiment of a sample method of defining the campaign by associating ad content from the repository with the campaign and also selecting the type of campaign. Prior to getting to this point, there may be an entry area for the Campaign ID (CID) and a short description (recommend 64 characters free text, non-unique). Due to the discovery and reserve actions, the system may already know the delivery media for the campaign (sms, wap, etc.). A campaign creation act may allow the campaign to be saved as a draft in my campaigns or to be saved and submitted for approval by the publisher(s).

Update. If an advertiser changes its requirements either unilaterally or in response to feedback from the publisher, then a method must be provided to edit/update the ad content and resubmit to the publisher for approval. Where an update to content for a single campaign causes an update to the ad content in the repository, one behavior is that if one updates the campaign data such as round robin instead of sequential by user then there is no ad content change required. If one changes ad content, then the user will be prompted to update the ad content for all campaigns and given the list of effected campaigns or to update the ad content only for this campaign. If they choose all campaigns, then ad content may be resubmitted for approval to all publishers. If the pick only this campaign, then the ad content is copied and a new name prompted for and then it is resubmitted to the publisher(s) for this campaign only. Where an update content in the repository is desired that automatically updates the content in one or more pending ad campaigns, the user can update the content, but then, in one embodiment, the user may be given a prompt to determine whether they really want to update content for all of the campaigns (see previous note). If a repository update causes an update to a pending ad campaign, a notification and re-approval process is provided, in one embodiment, that may be same as the normal process.

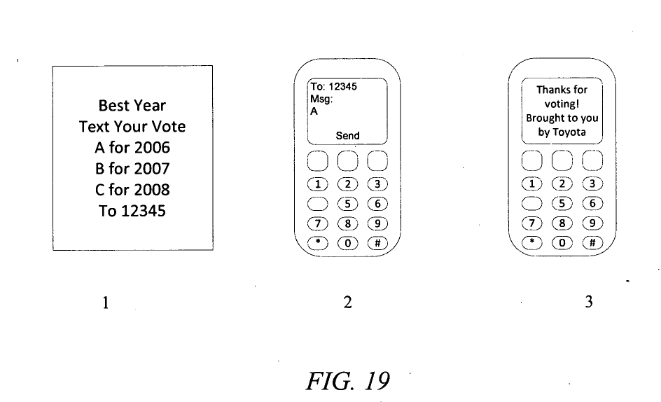

Preview. One embodiment may include a preview function. One embodiment may show the advertiser what the campaign may look like. The publisher can select from a handful of simple predefined campaign types (see the publisher inventory definition description). A preview pop up could be provided that walks the advertiser through how the campaign will appear using generic campaign text with their own ad content embedded. FIG. 19 provides one embodiment, of a preview for a campaign.

Track. Advertisers may designate certain campaigns that they wish to track. Method of tracking may include via either email or sms message, or both. If an advertiser elects to track a campaign, they might be sent a summary message showing number of impressions, number of uniques, and number of ads served. Timing of the message may be as follows: if an campaign has a discrete end time such as will be the case for most high capacity campaigns associated with tv shows, then the tracking message may go out as soon after the end time as practical. If an campaign is ongoing (daily alerts, etc), then the tracking message may go out following midnight in the last timezone (Alaska or Hawaii) and may include data for the previous day. Advertisers may set up a default for the tracking function that specifies method of delivery as well as whether all campaigns in their business unit is to be tracked as a default or whether to default to no tracking.

Repository. The repository may be a library of actual ad content or a library of templates. In one embodiment, a piece of ad content can be used like a template (copied, modified and saved) to create a new piece of ad content.

Create. A mechanism may be provided to enter the text (or import non-text items) for the ad content, that may include: a preview mode; dynamic sizing validation/display (i.e. real time character count with a change in color when the number of available characters has been exceeded. This may be coordinated with the fact that a repository item can be defined before a character limit is known); where there is a call to action, this might include a click to preview button for a url, a link to the brand's web site, etc. Additionally, the invention might maintain a call to action entry field for each piece of ad content to aid in the performance measurement of the ad. Allowable CTA types are:
Brand: this means there is a brand name but no particular action called for. Example “Buy Toyota cars!”.
Reply: this means that the user is being asked to reply via SMS with a keyword. Example “Reply to this message with Camry for a chance to win a Toyota Camry”
Link: this means that the message contains an embedded uri that can be hit either via phone or web. Example “See our fuel efficient models at Toyota.com”
Call: this means that the message contains an embedded phone number for the user to call. Example “Call 800-123-4567 to find the Toyota dealer in your town”

In one embodiment, the invention may prepopulate CTA data fields by using some simple character parsing on the text that is entered. For instance, if the text contains a viable phone number or uri, may prepopulate those items in the CTA text field with the appropriate types checked. The user may be allowed to override these choices.

Store. The invention may, in one embodiment, provide an intuitive storage structure for the repository ads that considers naming, filing, and directory conventions and control interfaces. One embodiment may also allow items to be made visible to others.

Find. A mechanism is provided for finding relevant repository items. This may include collecting metatag data on things like brand, product, character count, past performance, etc. It may further allow metatag searches and sorting as well as free text search of the ad content itself. Display of historical performance versus various demographic groups may also be provided.

Edit. One embodiment may provide an edit functions for repository items. One embodiment may allow saving the changes in a way that gives control over: whether to update the old item or create a new item; automatic highlighting that there is one or more pending purchases that use this item and may update them as well; and notification to all affected parties when a repository item is modified.

Delete. One embodiment may provide ability to delete a repository item, which may consider any pending purchases that require the item to exist.

Advertiser Admin Functions

Personal Advertiser Admin. One embodiment may provide standard login administrative functions including: (1) change password; (2) preferences; (3) mobile number; (4) method of notification (email, sms); (5) default timezone; (6) brand name; (6) product name; (7) tracking default; and the like.

Group Advertiser Admin. This set of functions allows an Advertiser that has been designated to have admin capabilities to create, modify, and delete advertiser accounts. Advertiser accounts may inherit the access and roles of the parent account with the ability of the parent account to modify that be deselecting functions to disable them. Group admin may also control Account wide and/or Business Unit wide preferences for various settings.

Administrator Functions

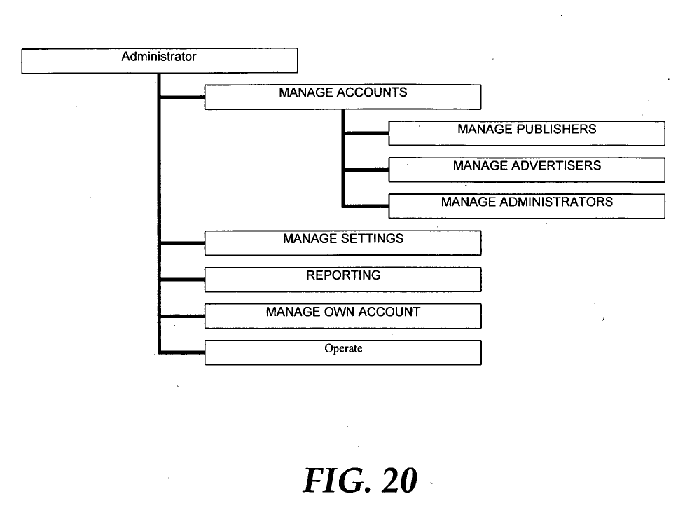

One non-limiting embodiment, of an Ad Axis Administrator functional tree is shown in FIG. 20. There may be 4 basic types of admin users, including:
Viewer. A viewer is a user that has the ability to view reports, publisher, and advertiser data, but may not allowed to edit or perform operations on that data. An example of a Viewer type of user is the CEO who may want to see either a global report or the view that a key customer sees, but does not need to change any settings.
Professional Services User. A professional services user may act on behalf of either publisher or advertiser customers. In order to perform their actions, they need the ability to select the Company, business unit, and role that they are going to assume. Once they assume this role, they may have access to the same views and operations that a customer with the from the same company and business unit would have in that role. The professional services user's actions should be recorded as their own actions and not as the customer's actions for audit purposes.
Administrator. An administrator has the full capability to create and delete all types of users as well as edit global platform settings.
Operator. An operator is a subclass of an administrator. This subclass requires a status display and emergency override actions.

Viewer and professional services users might not need to be admin users. They might just as well be publisher or advertiser users or some type of combined publisher/advertiser user. However, they may be included them in the admin section because both of these types of users are most likely may seek access to the system at a higher level than customer users. Aside from the ability to control their access by designating which customer, business unit, and role they are assuming, there might not need to be any new views or system actions created for these two user classes. Their views and actions might be those already available to publishers and advertisers.

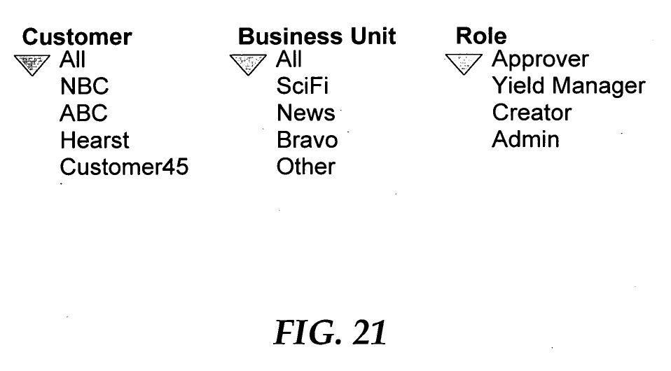

View. Both the Viewer type of user and the Professional Services type of user may enable selection and control what type of access they currently have. Some type of continually visible pulldown menu item in the top nav area may be provided for this. FIG. 21 illustrates one embodiment, of a menu useable for views. They will also be able to pick between publisher and advertiser (not shown).

The invention may further allow the viewer and prof svc users to set a default customer, business unit, and role in the personal settings. If they do not set these, they may default to Publisher, All, All, or the like.

The default view for a viewer may be the publisher calendar or list view unless they designate a different view as their default. Once they've set up their profile for default company, business unit, etc, they may pick from the defaults and settings normally available to that class of user.

Professional Services. Professional Services functions may be substantially the same as Viewer functions except that they may also include all of the roles available to both advertisers and publishers whereas the viewer roles might only allow non editing roles.

Default View for Admin Users. One default view includes the operator dashboard showing the system health, performance, and active campaigns/iids. The user may have the ability to set a new default view in their profile (create users, view reports, etc.)

Manage Accounts

Manage Publisher Accounts. Functions may include: (1) set up publishers and business units; (2) create, modify, delete publisher logins; (3) set up publisher account access rules and roles; (4) tie publishers to settlement accounts; (5) load publisher logo for branding purposes; (6) define publisher global exceptions, business unit exceptions, and list of exception items; and/or (7) at a business unit level, define a default geography.

Manage Advertiser Accounts. Functions may include: (1) set up advertisers and business units; (2) create, modify, delete advertiser logins; (3) set up advertiser account access rules and roles; (4) tie advertisers to settlement accounts; (5) load advertiser logo for branding purposes; (6) define advertiser default exceptions (no competitor campaigns for instance); (7) define default geographic and timezone constraints at both a company and business unit level; and/or (8) define default demographic settings at both company and business unit levels

Manage Administrator Accounts. Various settings are included that can be managed including: (1) set up default values for global settings (timezone, currency, etc.); (2) messaging control; (3) enter and send a system message. This may establish a single recipient, group of recipients, or system wide message as well as a time to send the message and an urgency of the message.

Reports. Various reports are provided for, including: a series of settlement reports; one or more performance reports (# of impressions vs forecast, click through rates, etc.) and aggregate total data (# of ads sold, % of inventory sold, # of unused inventory) reports.

Operate

The operator view provides a status dashboard for the system as a whole that shows the following types of information, such as health, load/performance and/or active statistics. Health information may include process status, interface status, number of active logins. Load/performance view can comprise latency, current or recent transactions per second, etc. Active statistics can provide data regarding currently active campaigns. I suspect this should be some variation on the Yield Manager view. For Active campaigns/IIDs, the operator may have the capability to provide the following emergency actions: (1) Stop/Pause/Resume serving ads for the campaign. In the stop or paused mode, the ad server should still respond to the AA but with no ad data; (2) change a campaign from normal to high capacity and vice versa; and/or (3) display contact information for the publisher and advertiser contacts associated with the campaign and IID and any emergency contact info available for those companies.

The operator does not need to take any other actions in the operator role. If there are other actions to be taken, they can be taken as an administrator.

What is claimed as new and desired to be protected is:

1. A mobile ad space purchasing system comprising: a web-based interactive ad marketplace system that enables publishers of text and media content to create, manage and sell an inventory of mobile messages and further enables advertisers to discover said inventory, and to create, manage and submit ads for storage into one or more ad servers for insertion into said inventory's ad-eligible message.

2. The system of claim 1, further comprising an ad inserter configured to receive an ad-eligible message, formulate an ad request and insert a returned ad into said ad eligible message.

3. The system of claim 2, further comprising an ad requester, which is configured to receive the ad request; retrieve one or more ads from one or more ad marketplace servers in response to the ad request; and to store the one or more ads.

4. The system of claim 1, wherein the ad marketplace system matches a specific ad to each individual ad-eligible message.

5. The system of claim 4, wherein the ad marketplace system matches the specific ad to the individual ad-eligible message that is specific to a recipient employing know information about the recipient, including but not limited to: general demographics, prior campaign participation, patterns of advertisement distribution related to prior messages to the recipient.

6. The system of claim 1, wherein the mobile ad space purchasing system is configured to insert the ad into the ad-eligible message and transmit the message to an end user in real-time and in line with the delivery of the message during a publisher's mobile messaging campaign.

7. A method of purchasing ad space on a mobile message comprising:
receiving from an advertiser a request for purchase of ad space on one or more ad-eligible message associated with a publisher's mobile messaging campaign;
notifying the publisher of the advertiser's request to purchase ad space; and
enabling a transaction relating to the purchase of ad space on one or more ad-eligible mobile messages in the publisher's mobile messaging campaign.

8. The method of claim 7, further comprising the step of: the publisher describing an inventory of mobile messaging campaigns.

9. The method of claim 8, further comprising the step of: the advertiser describing an inventory of one or more ad.

10. The method of claim 9, further comprising the step of: providing an on-line ad marketplace that enables the exchange of information between the publisher and advertiser so that they can match their respect ad inventory to a mobile messaging campaign.
